(19) United States
(12) Patent Application Publication
(10) Pub. No.: US 2010/0157510 A1
(43) Pub. Date: Jun. 24, 2010

(54) SOLID ELECTROLYTIC CAPACITOR

(75) Inventors: Yuji Miyachi, Daito-shi (JP); Kohei Goto, Daito-shi (JP); Koichi Morita, Hirakata-shi (JP); Takeshi Takamatsu, Daito-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/639,520

(22) Filed: Dec. 16, 2009

(30) Foreign Application Priority Data
Dec. 24, 2008 (JP) 2008-327551

(51) Int. Cl. H01G 9/15; H01G 9/025

(52) U.S. Cl. 361/524; 361/525; 977/742; 977/932

(57) ABSTRACT

A solid electrolytic capacitor includes a capacitor element including: an anode body; a dielectric coating film deposited on a surface of the anode body; a conductive polymer layer deposited on the dielectric coating film; and a mixture layer deposited on the conductive polymer layer and containing a conductive matrix and carbon nanotubes, the anode body, the dielectric coating film, the conductive polymer layer and the mixture layer being deposited in sequence.

### BACKGROUND OF THE INVENTION

1. Field of the Invention

The present invention relates to solid electrolytic capacitors providing high performance.

2. Description of the Related Art

In recent years there has been a demand for a small size and large capacity capacitor for high frequency as electronic equipment is reduced in size and weight. As one such capacitor there has been proposed a solid electrolytic capacitor employing a conductive polymer compound to form a solid electrolyte layer.

A solid electrolytic capacitor may have a basic configuration including an anode body formed of a sintered compact of tantalum, niobium, titanium, aluminum or similar valve metal, a dielectric coating film formed of an oxidized surface of the anode body, a solid electrolyte layer formed of a conductive polymer layer deposited on the dielectric coating film, a carbon layer, and a cathode body. The cathode body may be a silver paste or similar metal paste layer.

The above solid electrolytic capacitor has the carbon layer provided as a current collecting layer associated with the cathode. Accordingly, the carbon layer's specific surface and affinity with the conductive polymer layer and cathode body adjacent thereto are important. Accordingly, a variety of studies have been underway for the carbon layer.

Generally, a conductive polymer layer has been deposited on a dielectric coating film, as follows: A chemical oxidative polymerization method is used to previously deposit a partial conductive polymer layer covering a portion on the dielectric coating film and subsequently an electro-oxidative polymerization method is employed to deposit an entire conductive polymer layer covering an entire surface on the dielectric coating film. However, a variety of factors prevent a solid electrolytic capacitor from having a conductive polymer layer deposited with a desired conductance, and studies are currently still underway.

As such, it is noted what material should be used to form a conductive polymer layer, and utilizing carbon nanotube to enhance a solid electrolytic capacitor in performance has been attempted. For example, a conductive polymer layer is formed of a conductive polymer and carbon nanotube mixed together to provide a solid electrolytic capacitor enhanced in conductance (see Japanese Patent Laying-open No. 2005-085947). Japanese Patent Laying-open No. 2005-085947 discloses a solid electrolytic capacitor utilizing carbon nanotube and low in equivalent series resistance (ESR).

Japanese Patent Laying-open No. 2005-085947 indicates that the solid electrolytic capacitor including the conductive polymer layer utilizing carbon nanotube is higher in conductance than a solid electrolytic capacitor including a conductive polymer layer formed only of a conductive polymer and as a result provides high performance, such as low ESR.

### SUMMARY OF THE INVENTION

Japanese Patent Laying-open No. 2005-085947 discloses a solid electrolytic capacitor which notes a conductive polymer layer, and it is necessary therefor to comprehensively assess leakage current (LC), heat resistance and the like and further its development.

Currently, development of a low ESR, low LC, and reliable solid electrolytic capacitor is still hastened. Accordingly, the present inventors have noted a novel method of utilizing carbon nanotube in a solid electrolytic capacitor and diligently studied to achieve a low ESR, low LC, and reliable solid electrolytic capacitor. The present invention provides a solid electrolytic capacitor that does not include a carbon layer as conventional and instead includes a mixture layer containing a conductive matrix and carbon nanotube to achieve low ESR, low LC, and high heat resistance.

The present invention provides a solid electrolytic capacitor including a capacitor element including: an anode body; a dielectric coating film deposited on a surface of the anode body; a conductive polymer layer deposited on the dielectric coating film; and a mixture layer deposited on the conductive polymer layer and containing a conductive matrix and carbon nanotubes, the anode body, the dielectric coating film, the conductive polymer layer and the mixture layer being deposited in sequence.

Preferably in the present solid electrolytic capacitor the mixture layer is deposited such that particles of the conductive matrix adhere to the carbon nanotubes.

Preferably in the present solid electrolytic capacitor the mixture layer is deposited such that the carbon nanotubes are dispersed in the conductive matrix.

Preferably in the present solid electrolytic capacitor the mixture layer is equal to or smaller than the conductive polymer layer in thickness.

Preferably in the present solid electrolytic capacitor the mixture layer has a thickness of 1 to 10 μm and the conductive polymer layer has a thickness of 15 to 120 μm.

The present solid electrolytic capacitor may include a carbon layer further deposited on the mixture layer.

The present invention can thus provide a low ESR, low LC, and significantly heat resistant solid electrolytic capacitor.

The foregoing and other objects, features, aspects and advantages of the present invention will become more apparent from the following detailed description of the present invention when taken in conjunction with the accompanying drawing.

### BRIEF DESCRIPTION OF THE DRAWING

FIG. 1 is a schematic cross section of a sintered solid electrolytic capacitor in an embodiment of the present invention.

### DESCRIPTION OF THE PREFERRED EMBODIMENTS

Hereinafter reference will be made to the drawing to describe the present invention in an embodiment. In the FIGURE, identical or corresponding components are identically denoted and will not be described repeatedly. Furthermore, in the drawing, length, size, width and other similar dimensional relationship are changed as appropriate for clarification and simplification, and do not indicate actual dimension.

<Structure of Solid Electrolytic Capacitor>

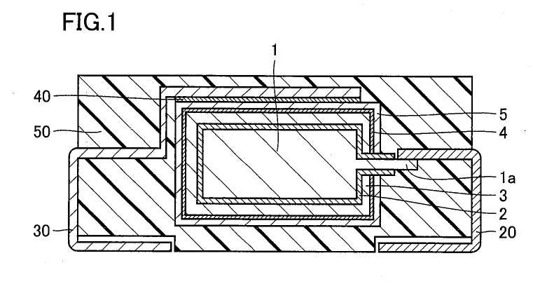

Reference will be made to FIG. 1 to describe one example in structure of a solid electrolytic capacitor in an embodiment of the present invention. FIG. 1 is a schematic cross section of a sintered solid electrolytic capacitor of the present embodiment. Note that the present solid electrolytic capacitor is not limited to a sintered type; it is applicable to any known geometry.

The present solid electrolytic capacitor internally has a cubic anode body 1, and anode body 1 is surrounded by a dielectric coating film 2 formed of oxide coating film on a surface of anode body 1. On dielectric coating film 2 a conductive polymer layer 3 is deposited and thereon a mixture layer 4 is deposited. On mixture layer 4 a silver paste layer 5 is deposited. Anode body 1 is provided with an externally projecting, cylindrical tantalum wire 1a.

The solid electrolytic capacitor has wire 1a configuring an anode portion and silver paste layer 5 configuring a cathode portion. In the present specification in the following description wire 1a will also be referred to as an anode portion 1a.

Anode portion 1a has an anode terminal 20 in the form of a flat plate electrically bonded thereto by resistance welding. Furthermore, cathode portion 5 has a cathode terminal 30 in the form of a flat plate electrically bonded thereto with a silver adhesive material or a similar conductive adhesive 40. Coating resin 50 protects the entirety of the solid electrolytic capacitor.

Mixture layer 4 contains a conductive matrix and carbon nanotubes. The conductive matrix can for example be polyaniline, polythiophene, polypyrrole or a similar conductive polymer.

The carbon nanotubes can be that generally used.

Furthermore, the present invention in one embodiment preferably provides mixture layer 4 containing carbon nanotubes with the conductive matrix's particles adhering thereto. In that case, the conductive matrix acts as a binding agent binding the carbon nanotubes together.

Furthermore, the present invention in another embodiment preferably provides mixture layer 4 containing carbon nanotubes dispersed in the conductive matrix. In that case, the conductive matrix acts as a dispersing agent dispersing carbon nanotubes.

Mixture layer 4 is preferably equal to or smaller than conductive polymer layer 3 in thickness. Mixture layer 4 exceeding conductive polymer layer 3 in thickness may result in poor productivity or peel off or the like resulting in a capacitor having poor characteristics.

Furthermore, it is particularly preferable that mixture layer 4 is 1 to 10 μm in thickness and that conductive polymer layer 3 is 15 to 120 μm in thickness. Mixture layer 4 less than 1 μm in thickness provides the capacitor with varying characteristics. Mixture layer 4 exceeding 10 μm in thickness increases its own resistance. Thus, when mixture layer 4 has a thickness that does not fall within the above range, ESR is less effectively reduced. Furthermore, conductive polymer layer 3 less than 15 μm in thickness reduces an effect of repairing dielectric coating film 2 and may increase LC. Conductive polymer layer 3 exceeding 120 μm in thickness increases its own resistance. Thus, when conductive polymer layer 3 has a thickness that does not fall within the above range, ESR is less effectively reduced.

Furthermore in the present embodiment a carbon layer may be deposited on mixture layer 4. More specifically, the carbon layer may be deposited between mixture layer 4 and silver paste 5. Mixture layer 4 and the carbon layer in addition thereto allow the solid electrolytic capacitor to be fabricated with silver paste layer 5 having its affinity (e.g., adhesiveness) unchanged in the solid electrolytic capacitor.

The present invention can provide a solid electrolytic capacitor smaller in ESR than conventional. In particular, a solid electrolytic capacitor smaller in size more effectively decreases ESR.

Furthermore, anode body 1 is preferably formed of a metal having a valve effect, including aluminum, tantalum, niobium, titanium and the like. Note that dielectric coating film 2 utilizes oxide coating film deposited on a surface of anode body 1.

Furthermore, conductive polymer layer 3 is preferably formed using for example any of polyaniline, polythiophene and polypyrrole, and polypyrrole is particularly preferable.

<Method of Fabricating Solid Electrolytic Capacitor>

Reference will be made to FIG. 1 to schematically describe a method of fabricating a solid electrolytic capacitor in the present embodiment.

Anode portion 1a is planted in a compact of powder of metal having a valve effect. It is then vacuum-sintered to provide an anode body 1 having anode portion 1a provided thereto. Anode body 1 then undergoes a chemical treatment or an electrochemical treatment to provide dielectric coating film 2 formed of oxide coating film.

Then a well known chemical oxidative polymerization method or electro-oxidative polymerization method is employed to deposit conductive polymer layer 3 on dielectric coating film 2.

Then anode body 1 having dielectric coating film 2 with conductive polymer layer 3 deposited thereon is immersed in a polymer solution or a polymer dispersed solution which is to serve as a conductive matrix with carbon nanotubes added thereto and dispersed therein to provide a mixture liquid. It is then raised therefrom and dried to deposit mixture layer 4 on conductive polymer layer 3.

The mixture liquid may have a surfactant, a plasticizer, a dispersing agent, a painted surface control agent, a fluidity adjusting agent, a UV absorbing agent, an antioxidant, a preserving and stabilizing agent, an adhesion aid, a thickener, colloidal silica and/or other various types of known substances added thereto, as required.

Subsequently a well known method is employed to deposit silver paste layer 5 and anode terminal 20 is connected to anode portion 1a by resistance welding to fabricate a solid electrolytic capacitor. A well known method is employed to electrically bond anode terminal 20 in the form of a flat plate to anode portion 1a and electrically bond cathode terminal 30 in the form of a flat plate to silver paste layer 5 with a silver adhesive material or a similar conductive adhesive 40.

### EXAMPLES

Hereinafter the present invention will be described more specifically with reference to examples. However, the present invention is not limited thereto.

### Example 1

With reference to FIG. 1, an example 1 will be described. Anode portion 1a formed of tantalum is planted in a compact of powdery tantalum and vacuum-sintered to provide anode body 1 having anode portion 1a provided thereto. Then, a well known method is employed to subject the intermediate product to a chemical treatment or the like to prepare anode body 1 serving as an anode having a surface with dielectric coating film 2.

Then a polymerization solution containing pyrrole serving as a source material for conductive polymer layer 3, dopant and the like is prepared and employed in an electro-oxidative polymerization method to deposit conductive polymer layer 3 of 40 μm in thickness on dielectric coating film 2.

Then anode body 1 having dielectric coating film 2 with conductive polymer layer 3 deposited thereon is immersed in a liquid of mixture of a solution containing polyaniline serving as a conductive matrix and carbon nanotubes added thereto and dispersed therein. Anode body 1 is then raised from the mixture liquid and dried at 100° C. for 10 minutes. Furthermore, the intermediate product is again similarly immersed, raised and dried to deposit mixture layer 4 of 3 μm in thickness.

Subsequently a well known method is employed to deposit silver paste layer 5 and anode terminal 20 is connected to anode portion 1a by resistance welding to fabricate a solid electrolytic capacitor. A well known method is employed to electrically bond anode terminal 20 in the form of a flat plate to anode portion 1a and electrically bond cathode terminal 30 in the form of a flat plate to silver paste layer 5 with a silver adhesive material or similar conductive adhesive 40.

### Example 2

A solid electrolytic capacitor is fabricated similarly as done in example 1, except that after mixture layer 4 is deposited a 3 μm thick carbon layer is further deposited.

### Comparative Example 1

A solid electrolytic capacitor is fabricated similarly as done in example 1, except that mixture layer 4 is not deposited and a 3 μm thick carbon layer is instead deposited.

<Evaluation of Performance>

(1) Initial Value

165 solid electrolytic capacitors are fabricated for each of example 1, example 2, and comparative example 1. Each example's capacitors have their ESRs and LCs measured as their initial characteristics and their respective average values are calculated and their comparisons are indicated in table 1. Note that ESR is data for a frequency of 100 kHz.

(2) Reliability

After their initial characteristics are measured, example 1 and comparative example 1 have their respective solid electrolytic capacitors subjected to a reflow test conducted as a reliability test repeatedly 12 times and thereafter their ESRs are measured. A rate at which each solid electrolytic capacitor having undergone the reflow test has its ESR increased relative to an initial value is evaluated as reliability. The reflow test is conducted with each solid electrolytic capacitor held at 217° C. or higher, with 260° C. set as a maximum temperature, for 90 seconds. A solid electrolytic capacitor having an ESR increased at a smaller rate, i.e., having larger heat resistance, after it has undergone the reflow test is evaluated as having higher reliability.

TABLE 1

| | Initial Value | | |
|---|---|---|---|
| | ESR | LC | Reliability (rate at which ESR is |
| | (mΩ) | (μA) | increased after reflow test (%)) |
| Example 1 | 15.2 | 10 | +46 |
| Example 2 | 17.7 | 10 | — |
| Comparative Example 1 | 19.0 | 10 | +57 |

As can be seen from table 1, the solid electrolytic capacitors of examples 1 and 2 are lower in ESR than those of comparative example 1 and have leakage current unchanged. Furthermore, example 1 after the reflow test provides an ESR increased at a rate smaller than comparative example 1, and thus indicates high reliability.

It should be understood that the embodiment and examples disclosed herein are illustrative and non-restrictive in any respect. The scope of the present invention is defined by the terms of the claims, rather than the description above, and is intended to include any modifications within the scope and meaning equivalent to the terms of the claims.

What is claimed is:

1. A solid electrolytic capacitor comprising a capacitor element including:
an anode body;
a dielectric coating film deposited on a surface of said anode body;
a conductive polymer layer deposited on said dielectric coating film; and
a mixture layer deposited on said conductive polymer layer and containing a conductive matrix and carbon nanotubes, said anode body, said dielectric coating film, said conductive polymer layer and said mixture layer being deposited in sequence.

2. The solid electrolytic capacitor according to claim 1, wherein said mixture layer is deposited such that particles of said conductive matrix adhere to said carbon nanotubes.

3. The solid electrolytic capacitor according to claim 1, wherein said mixture layer is deposited such that said carbon nanotubes are dispersed in said conductive matrix.

4. The solid electrolytic capacitor according to claim 1, wherein said mixture layer is equal to or smaller than said conductive polymer layer in thickness.

5. The solid electrolytic capacitor according to claim 4, wherein said mixture layer has a thickness of 1 to 10 μm and said conductive polymer layer has a thickness of 15 to 120 μm.

6. The solid electrolytic capacitor according to claim 1, wherein a carbon layer is further deposited on said mixture layer.
